(19) United States
(12) Patent Application Publication
(10) Pub. No.: US 2011/0235169 A1
(43) Pub. Date: Sep. 29, 2011

(54) MICROSCOPE MODULE

(75) Inventors: Hyun Chang LIM, Seoul (KR); Neon Cheol JUNG, Anyang-si (KR); Keun Chang CHO, Seoul (KR)

(73) Assignee: LOGOS BIOSYSTEMS, INC., Anyang-si (KR)

(21) Appl. No.: 13/044,125

(22) Filed: Mar. 9, 2011

(30) Foreign Application Priority Data
Mar. 23, 2010 (KR) 10-2010-0025723

(51) Int. Cl. G02B 21/04

(52) U.S. Cl. 359/380

(57) ABSTRACT

Disclosed is a microscope module. The microscope module includes an objective lens magnifying an image of a sample subject for observation; an observation part for observing the image of the sample magnified through the objective lens; and a reflective mirror provided between the objective lens and the sample such that the vertical distance between the sample and the objective lens is substantially reduced. Since the reflective lens is disposed between the objective lens and the observation part, the working distance from the sample to the objective lens is substantially reduced, so that the height of the microscope is remarkably reduced. Thus, the microscope may be used in a place with vertical spatial limitations.

### TECHNICAL FIELD

The present invention relates to a microscope module. More particularly, the present invention relates to a microscope module, in which a reflective mirror is disposed between a sample and an objective lens magnifying an image of the sample, and the objective lens and other optical parts are aligned on the same horizontal plane such that a vertical distance between the sample and the objective lens can be substantially reduced, thereby remarkably lowering the height of the microscope so that it may be used in a place with vertical spatial limitations.

### BACKGROUND ART

Microscopes are used to magnify objects and microorganisms which are invisible to the naked eye so that they may be observed. Microscopes are extensively used in various fields and classified into various types according to the shape, manufacturing date, manufacturers, and applications thereof. Besides a normal transmission microscope, special microscopes, such as a metal microscope, a polarization microscope, a phase contrast microscope, or a UV microscope, have been extensively used.

Various attempts have been made to miniaturize the size of microscopes to reduce the size of the equipment including the microscope optical structure or to facilitate the transportation of the microscope such that the microscope can be used in various fields without spatial limitations.

Microscopes have an optical structure including a light source, an objective lens, an ocular lens and a detector. Such an optical structure of the microscope can be adopted in various types of equipment, such as an observation apparatus for observing micro structures or an analysis apparatus for performing analysis by collecting weak light.

For instance, the optical structure of a microscope is employed in an automatic cell counter, a luminometer, a fluorometer, an image cytometer or real-time PCR equipment.

According to the optical structure of the microscope of the related art, the objective lens is installed vertically to the sample subject and to the observation so as to ensure the working distance between the sample and the objective lens in the vertical direction such that the image of the sample can be transferred to the objective lens. In addition, since a normal objective lens has a long cylindrical structure in a vertical direction, the microscope has a predetermined height in the vertical direction by taking the distance of the sample-working distance-objective lens into consideration. Due to the above arrangement of the microscope, the light source, the sample and the objective lens are aligned in the vertical direction, so the height of the microscope is therefore increased. Therefore, if there are spatial limitations, the microscope cannot adopt the above optical structure.

In order to provide a microscope module having a compact structure, U.S. Pat. No. 6,198,573 (issued to Carl-Zeiss) discloses a microscope including optical parts aligned on a beam path having a Z-shape. According to the above patent, light irradiated from a light source is reflected at an angle of 45° by a mirror, and then the light is irradiated onto a sample. In addition, an image of the sample transferred to an objective lens, which is aligned vertically to the sample, is reflected at an angle of 45° and then the image is transferred to a detector. According to the above arrangement, the light source and the sample can be arranged in a horizontal direction and the objective lens and the detector can be arranged in the horizontal direction, so the height of the microscope can be reduced.

However, the vertical distance between the sample and the objective lens may not be reduced alike the microscope according to the related art.

Meanwhile, U.S. Pat. No. 6,594,075 (issued to Olympus) discloses a compact microscope usable in a place having spatial limitations. According to the above patent, an LED light source, a sample, an objective lens and an image sensor are aligned on an optical axis in a vertical direction, and an electronic apparatus is disposed at a rear of the lens, so that the microscope has a long structure in the vertical direction. However, although the microscope having the above structure can be effectively used in a place having spatial limitations in a horizontal direction, it may not be used in a place having spatial limitations in a vertical direction.

In addition, U.S. Pat. No. 6,452,625 (issued to Leica) discloses another compact microscope. According to the above patent, an image obtained from an image sensor is displayed on a display unit, which is provided in place of an ocular lens. Thus, the above patent may not improve the optical structure of the microscope.

Therefore, it is necessary to develop a microscope module, which can be conveniently used in a place having spatial limitation by substantially reducing the vertical distance between a sample and an objective lens and may allow equipment having an optical structure of a microscope to be manufactured in a compact size.

### SUMMARY OF THE INVENTION

It is an object of the present invention to provide a microscope module, in which a reflective mirror is disposed between a sample and an objective lens magnifying an image of the sample and the objective lens, and other optical parts are aligned on the same horizontal plane such that a vertical distance between the sample and the objective lens can be substantially reduced, thereby remarkably lowering the height of the microscope so that it may be used in a place with vertical spatial limitations.

To achieve the above object, the present invention provides a microscope module including an objective lens magnifying an image of a sample subject for observation; an observation part for observing the image of the sample magnified through the objective lens; and a reflective mirror provided between the objective lens and the sample such that a vertical distance between the sample and the objective lens is substantially reduced.

The reflective mirror reflects the image of the sample, which is aligned on a first virtual line inclined by a predetermined angle with respect to a second virtual line connecting the objective lens with the observation part, toward the objective lens.

A mirror surface of the reflective mirror is inclined by a predetermined angle with respect to the second virtual line connecting the objective lens with the observation part.

The objective lens is a low magnification lens that magnifies the image of the sample by one to ten times.

The microscope module further includes a zoom lens disposed between the objective lens and the observation part to magnify the image of the sample.

The zoom lens is disposed on the second virtual line connecting the objective lens with the observation part.

The microscope module further includes an objective lens distance adjustment part for moving the objective lens to adjust a distance between the objective lens and the reflective mirror.

The objective lens distance adjustment part includes a first driving motor and a first power transmission to transfer power of the first driving motor to the objective lens.

The first driving motor includes a linear motor, and the first power transmission includes a first driving shaft coupled with an objective lens holder for receiving the objective lens, a first guide rail adjacent to the first driving shaft, and a first guide block coupled to a lower portion of the objective lens holder to move relative to the first guide rail as the first driving shaft is driven.

The microscope module further includes a detection sensor provided between the objective lens and the reflective mirror to detect a distance between the reflective mirror and the objective lens.

The microscope module further includes a zoom lens distance adjustment part for moving the zoom lens to adjust a distance between the zoom lens and the observation part.

The zoom lens distance adjustment part includes a second driving motor and a second power transmission to transfer power of the second driving motor to the zoom lens.

The second driving motor includes a linear motor, and the second power transmission includes a driving block coupled with a zoom lens holder for receiving the zoom lens to transfer power of the second driving motor to the zoom lens, a second guide rail adjacent to a lower portion of the zoom lens, and a second guide block coupled to a lower portion of the zoom lens holder to move relative to the second guide rail as the driving block is moved.

The observation part includes one of an ocular lens, a camera, a photodiode, and a PMT (photo multiplier tube).

The microscope module further includes a first housing and a second housing coupled with the first housing to form an installation space where the objective lens and the reflective lens are installed. The sample is received in a sample receiving part inserted into a sample insertion hole formed through the first housing, and the reflective mirror is disposed at a lower portion of the sample receiving part.

The mirror surface of the reflective mirror is inclined by an angle of 45° with respect to the second virtual line connecting the objective lens with the observation part.

According to the microscope module of the present invention, a reflective mirror is disposed between a sample and an objective lens magnifying an image of the sample and the objective lens and other optical parts are aligned on the same horizontal plane such that a vertical distance between the sample and the objective lens can be substantially reduced, thereby remarkably lowering the height of a microscope and conveniently using the microscope in a place having spatial limitations in a vertical direction.

### BRIEF DESCRIPTION OF THE DRAWINGS

FIG. 1 is an assembled perspective view of a microscope module according to one embodiment of the present invention;

FIG. 2 is a perspective view showing an internal structure of a microscope module illustrated in FIG. 1 when viewed from an objective lens;

FIG. 3 is a perspective view showing an internal structure of a microscope module illustrated in FIG. 1 when viewed from an observation part; and

FIG. 4 is a side sectional view showing a microscope module illustrated in FIG. 1.

### DETAILED DESCRIPTION OF THE INVENTION

Hereinafter, the present invention will be described in further detail with reference to the accompanying drawings. In the following description of the present invention, description about known functions and structures will be omitted if they make the subject matter of the present invention unclear.

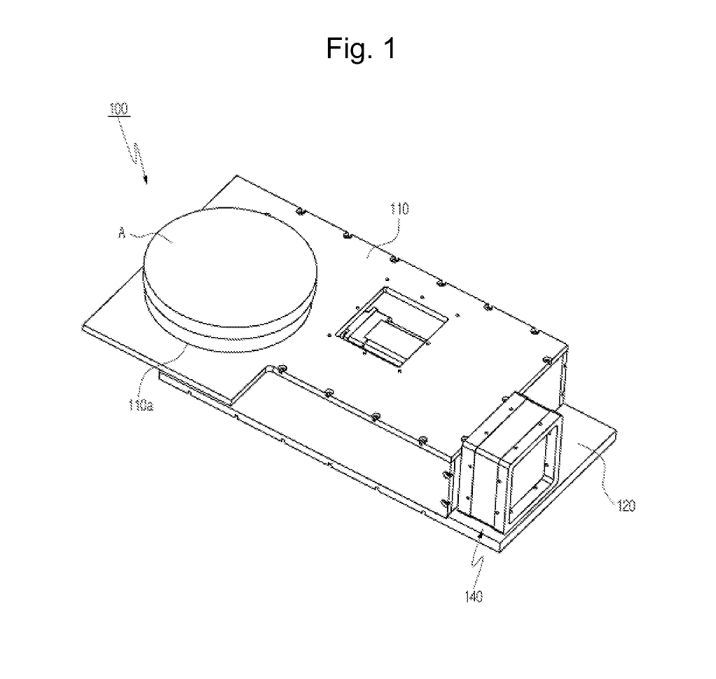

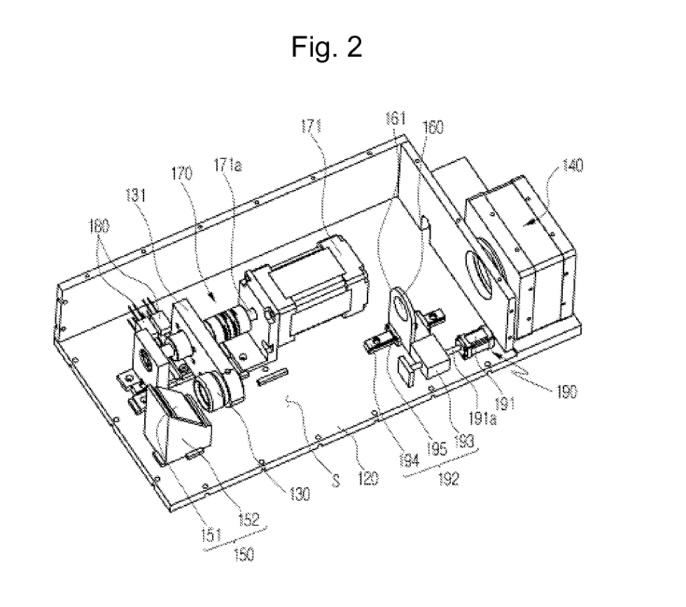

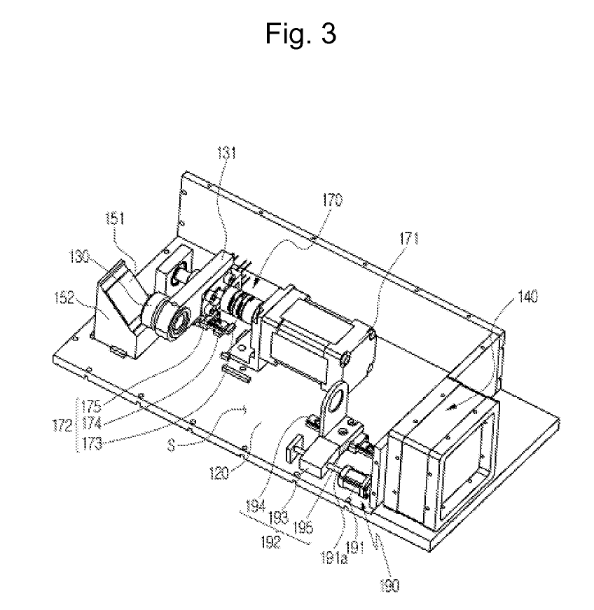

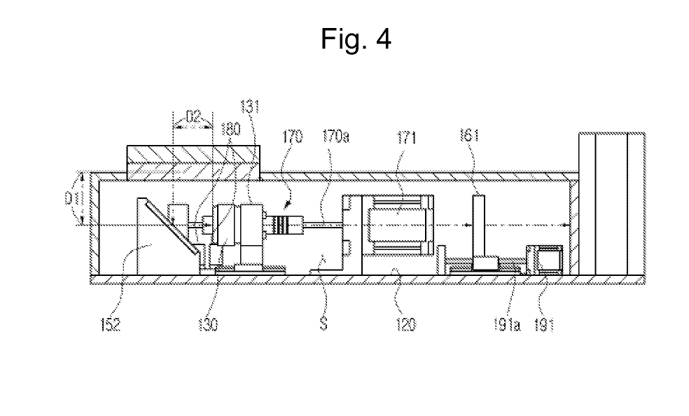

FIG. 1 is an assembled perspective view of a microscope module according to one embodiment of the present invention, FIG. 2 is a perspective view showing an internal structure of the microscope module illustrated in FIG. 1 when viewed from an objective lens, FIG. 3 is a perspective view showing an internal structure of the microscope module illustrated in FIG. 1 when viewed from an observation part, and FIG. 4 is a side sectional view showing the microscope module illustrated in FIG. 1.

Referring to FIGS. 1 to 4, the microscope module 100 according to one embodiment of the present invention includes first and second housings 110 and 120, which are coupled with each other to serve as an external frame while forming an installation space S therein, an objective lens 130 installed in the installation space S to magnify an image of the sample subject to the observation, an observation part 140 for observing the image of the sample magnified through the objective lens 130, a reflective mirror 150 disposed between the objective lens 130 and the sample such that the vertical distance between the sample and the objective lens 130 can be substantially reduced, and a zoom lens 160 disposed between the objective lens 130 and the observation part 140 to magnify the image of the sample.

In the following description, when the microscope module 100 is horizontally aligned, the vertical distance between the sample and the objective lens 130 signifies the distance obtained by subtracting the distance between the horizontal plane and the objective lens 130 from the distance between the horizontal plane and the sample. That is, the vertical distance signifies the distance D1 shown in FIG. 4. In addition, the reflective mirror 150 can be replaced with a prism.

The first housing 110 constitutes an upper frame of the microscope module 100 and forms the installation space S together with the second housing 120 in such a manner that the objective lens 130, the reflective mirror 150 and the zoom mirror 160 can be installed in the installation space S. A sample insertion hole 110a is formed at one end of the first housing 110 adjacent to the objective lens 130 and a sample receiving part A is inserted into the sample insertion hole 110a.

The second housing 120 constitutes a lower frame of the microscope module 100 and forms the installation space S together with the first housing 110. A reflective mirror holder 152, a first guide rail 174 and a second guide rail 194 are fixedly installed on a top surface of the second housing 120. The top surface of the second housing 120 is flattened, so that the objective lens 130, the reflective mirror 150 and the zoom mirror 160 can be aligned on the same horizontal plane in series. In addition, the installation space S defined by the first and second housings 110 and 120 has a rectangular hexahedral shape with a low height such that the sample can be observed in the horizontal direction.

If necessary, the first and second housings 110 and 120 can be omitted. In addition, the installation space S defined by the first and second housings 110 and 120 may have various shapes.

Meanwhile, the objective lens 130 magnifies the image of the sample, which is received in the sample receiving part A, as the image of the sample is reflected from the reflective mirror 150. The objective lens 130 is fixedly coupled with an objective lens holder 131 and the distance between the objective lens 130 and the reflective mirror 150 can be adjusted by an objective lens distance adjustment part 170, which will be described later. In detail, as the objective lens distance adjustment part 170 is driven, the objective lens 130 is moved closely to or away from the reflective mirror 150, so that the image of the sample reflected from the reflective mirror 150 can be focused and the observer can observe the magnified image of the sample through the observation part 140. According to the present embodiment, the objective lens 130 is a low magnification lens that magnifies the image of the sample by one to ten times.

The observation part 140 allows an observer to observe the image of the sample, which is magnified through the reflective mirror 150, the objective lens 130 and the zoom lens 160. According to the present embodiment, the observation part 140 includes one of an ocular lens, a camera (including digital camera), a photodiode, and a PMT (photo multiplier tube).

The ocular lens magnifies the image formed through the objective lens, and the camera refers to an optical appliance used in various fields, such as the medical field, the industrial field and the academic field, to provide photos, such as news photos, commercial photos, construction photos, microscopic photos, Roentgen photos, aero photos, or astronomic photos. In addition, the photodiode refers an optical diode to convert optical energy into electric energy by adding a light detection function to a PN junction of a semiconductor, and the PMT refers to an apparatus capable of sensing the light by amplifying the light even if the light has weak intensity.

According to the present invention, the observation part 140 can be replaced with other devices capable of allowing the absorber to precisely recognize the image of the sample magnified through the objective lens 130 and the zoom lens 160. Thus, the technical scope of the present invention is not limited to the observation part 140 having the above structure.

Meanwhile, the reflective mirror 150 reflects the image of the sample received in the sample receiving part A toward the objective lens 130. The reflective mirror 150 is adjacent to a lower portion of the sample receiving part A.

A mirror surface 151 of the reflective mirror 150 is accommodated in the reflective mirror holder 152 and is disposed below the sample receiving part A while being inclined by an angle of 45° with respect to the virtual line connecting the objective lens 130 with the observation part 140. The reflective mirror 150 reflects the image of the sample toward the objective lens 130 such that the observer can observe the image of the sample through the observation part 140. If the above condition is satisfied, it is not necessarily required to incline the mirror surface 151 of the reflective mirror 150 by an angle of 45° with respect to the virtual line connecting the objective lens 130 with the observation part 140. According to another embodiment, the mirror surface 151 of the reflective mirror 150 can be inclined at various angles with respect to the virtual line connecting the objective lens 130 with the observation part 140.

The zoom lens 160 is disposed between the objective lens 130 and the observation part 140 to magnify the image of the sample, which has been magnified through the objective lens 130. The zoom lens 160 is aligned on the virtual line connecting the objective lens 130 with the observation part 140. That is, the objective lens 130, the zoom lens 160, and the observation part 140 are aligned to be in line with each other.

The zoom lens 160 is fixedly coupled with a zoom lens holder 161 and the distance between the zoom lens 160 and the objective lens 130 can be adjusted by a zoom lens distance adjustment part 190, which will be described later. In detail, as the zoom lens distance adjustment part 190 is driven, the zoom lens 160 is moved closely to or away from the objective lens 130, so that the image of the sample magnified by the zoom lens 160 can be focused and the observer can observe the magnified image of the sample through the observation part 140.

According to the present embodiment, the zoom lens 160 is very effective when the objective lens 130 is prepared as the low magnification lens. In this case, the zoom lens 160 magnifies the image of the sample that has been magnified with low magnification through the objective lens 130, so that the observer can sufficiently observe the image of the sample through the observation part 140. If the objective lens 130 is prepared as a high magnification lens, the observer can sufficiently observe the image of the sample through the observation part 140, so the zoom lens 160 can be omitted.

The microscope module 100 according to the present embodiment further includes the objective lens distance adjustment part 170 for moving the objective lens 130 back and forth, a detection sensor 180 disposed between the objective lens 130 and the reflective mirror 150 to detect the distance between the objective lens 130 and the reflective mirror 150, and the zoom lens distance adjustment part 190 for moving the zoom lens 160 back and forth.

The objective lens distance adjustment part 170 moves the objective lens 130 back and forth to adjust the distance between the objective lens 130 and the reflective mirror 150. The objective lens distance adjustment part 170 includes a first driving motor 171 and a first power transmission 172 to transfer power of the first driving motor 171 to the objective lens 130.

The first driving motor 171 generates power to move the objective lens 130 back and forth. According to the present embodiment, the linear motor is used as the first driving motor 171. Different from the conventional motor that rotates an object, the linear motor generates the power to linearly move the object. According to another embodiment of the present invention, the first driving motor 171 may include a solenoid device, a hydraulic/pneumatic motor, or a stepping motor. In addition, the objective lens distance adjustment part 170 can be manually operated without using the motor.

The first power transmission 172 transfers power of the first driving motor 171 to the objective lens 130 to move the objective lens 130 back and forth.

The first power transmission 172 includes a first driving shaft 173 coupled with a driving shaft 171a of the first driving motor 171, a first guide rail 174 provided below the first driving shaft 173, and a first guide block 175 that moves relative to the first guide rail 174.

One end of the first driving shaft 173 is coupled with the driving shaft 171a of the first driving motor 171 to transfer the driving force to the objective lens 130 in the forward and rearward direction. The other end of the first driving shaft 173 is coupled with the objective lens holder 131 receiving the objective lens 130. Different from the above embodiment, the driving shaft 171a of the first driving motor 171 can be directly coupled with the objective lens holder 131. In this case, the first driving shaft 173 can be omitted.

The first guide rail 174 is provided below the first driving shaft 173 and fixed to the top surface of the second housing 120 to guide the relative movement of the first guide block 175 integrally coupled with the objective lens holder 131. The top surface of the first guide block 175 is coupled with the objective lens holder 131 and the bottom surface of the first guide block 175 is moved relative to the first guide rail 174.

The first guide rail 174 and the first guide block 175 can be prepared in the form of an LM guide system, and detailed description thereof will be omitted. In addition, the technical scope of the present invention may not be limited to the first power transmission 172 having the above structure. According to another embodiment, the first power transmission 172 can be prepared by using a normal link system.

The detection sensor 180 is disposed between the objective lens 130 and the reflective mirror 150 to detect the distance between the objective lens 130 and the reflective mirror 150. The detection sensor 180 may include an optical sensor, a proximity sensor, a laser sensor, or an ultrasonic sensor to detect the distance between the objective lens 130 and the reflective mirror 150. Thus, the objective lens 130 can be prevented from excessively moving toward the reflective mirror 150. Since the distance between the objective lens 130 and the reflective mirror 150 can be accurately detected by the detection sensor 180, the observer can precisely observe the image of the sample.

The zoom lens distance adjustment part 190 moves the zoom lens 160 back and forth to adjust the distance between the zoom lens 160 and the observation part 140. The zoom lens distance adjustment part 190 includes a second driving motor 191 and a second power transmission 192 to transfer power of the second driving motor 191 to the zoom lens 160.

The second driving motor 191 generates power to move the zoom lens 160 back and forth. According to the present embodiment, the linear motor described above is used as the second driving motor 191. In addition, similar to the first driving motor 171, the second driving motor 191 may include a solenoid device, a hydraulic/pneumatic motor, or a stepping motor.

The second power transmission 192 transfers power of the second driving motor 191 to the zoom lens 160 to move the zoom lens 160 back and forth. The second power transmission 192 includes a driving block 193 coupled with the driving shaft 191a of the second driving motor 191, a second guide rail 194 provided below the zoom lens 160, and a second guide block 195 that moves relative to the second guide rail 194.

One end of the driving block 193 is coupled with the driving shaft 191a of the second driving motor 191 to transfer the driving force to the zoom lens 160 in the forward and rearward direction. The other end of the driving block 193 is coupled with the zoom lens holder 161. Different from the above embodiment, the driving shaft 191a of the second driving motor 191 can be directly coupled with the zoom lens holder 161. In this case, the driving block 193 can be omitted.

The second guide rail 194 is provided below the zoom lens 160 and fixed to the top surface of the second housing 120 to guide the relative movement of the second guide block 195 integrally coupled with the zoom lens holder 161. The top surface of the second guide block 195 is coupled with the zoom lens holder 161 and the bottom surface of the second guide block 195 is moved relative to the second guide rail 194.

The second guide rail 194 and the second guide block 195 can be prepared in the form of an LM guide system, and detailed description thereof will be omitted. In addition, the technical scope of the present invention may not be limited to the second power transmission 192 having the above structure. According to another embodiment, the second power transmission 192 can be prepared by using a normal link system and one zoom lens can be fixed to the bottom surface by a lens holder.

Hereinafter, the operation of the microscope module 100 according to the present invention will be briefly described.

After the sample subject to the observation is received in the sample receiving part A, the sample receiving part A is inserted into the sample insertion hole 110a formed in the first housing 110. In this case, the lower portion of the sample receiving part A is adjacent to the reflective mirror. The image of the sample received in the sample receiving part A is reflected toward the objective lens 130 through the mirror surface 151 of the reflective mirror 150.

The total working distance D ranging from the sample to the objective lens 130 is refracted by the reflective mirror 150, so the total working distance D is divided into a first working distance D1 ranging from the sample to the reflective mirror 150 and a second working distance D2 ranging from the reflective mirror 150 to the objective lens 130 (D=D1+D2).

That is, according to the microscope module 100 of the present embodiment, the reflective mirror 150 is disposed between the sample and the objective lens 130, so the vertical distance D1 between the sample and the objective lens 130 can be substantially reduced, so that the height of the microscope module 100 can be remarkably reduced.

The observer can magnify the image of the sample to the desired size by driving the objective lens distance adjustment part 170 and the zoom lens distance adjustment part 190. In addition, the image is precisely focused to the objective lens 130 and the zoom lens 160, so that the precise image of the sample can be obtained. In this state, the observer observes the image of the sample through the observation part 140.

As described above, according to the microscope module 100 of the present embodiment, the reflective mirror 150 is disposed between the objective lens 130 magnifying the image of the sample and the observation part 140 for observing the image of the sample magnified through the objective lens 130, so that the vertical distance between the sample and the objective lens 130 can be substantially reduced, thereby remarkably lowering the height of the microscope module 100 and conveniently using the microscope module 100 in a place having spatial limitation in a vertical direction.

Although the exemplary embodiments of the present invention have been described, it is understood that the present invention should not be limited to these exemplary embodiments but various changes and modifications can be made by a person skilled in the art within the spirit and scope of the present invention as hereinafter claimed.

What is claimed is:

1. A microscope module comprising:
an objective lens magnifying an image of a sample subject for observation;
an observation part for observing the image of the sample magnified through the objective lens; and
a reflective mirror provided between the objective lens and the sample such that the vertical distance between the sample and the objective lens is substantially reduced.

2. The microscope module of claim 1, wherein the reflective mirror reflects the image of the sample, which is aligned on a first virtual line inclined by a predetermined angle with respect to a second virtual line connecting the objective lens with the observation part, toward the objective lens.

3. The microscope module of claim 2, wherein a mirror surface of the reflective mirror is inclined by a predetermined angle with respect to the second virtual line connecting the objective lens with the observation part.

4. The microscope module of claim 1, wherein the objective lens is a low magnification lens that magnifies the image of the sample by one to ten times.

5. The microscope module of claim 1, further comprising a zoom lens disposed between the objective lens and the observation part to magnify the image of the sample.

6. The microscope module of claim 5, wherein the zoom lens is disposed on the second virtual line connecting the objective lens with the observation part.

7. The microscope module of claim 1, further comprising an objective lens distance adjustment part for moving the objective lens to adjust a distance between the objective lens and the reflective mirror.

8. The microscope module of claim 7, wherein the objective lens distance adjustment part includes a first driving motor and a first power transmission to transfer power of the first driving motor to the objective lens.

9. The microscope module of claim 8, wherein the first driving motor includes a linear motor, and the first power transmission includes a first driving shaft coupled with an objective lens holder for receiving the objective lens, a first guide rail adjacent to the first driving shaft, and a first guide block coupled to a lower portion of the objective lens holder to move relative to the first guide rail as the first driving shaft is driven.

10. The microscope module of claim 1, further comprising a detection sensor provided between the objective lens and the reflective mirror to detect a distance between the reflective mirror and the objective lens.

11. The microscope module of claim 5, further comprising a zoom lens distance adjustment part for moving the zoom lens to adjust a distance between the zoom lens and the observation part.

12. The microscope module of claim 11, wherein the zoom lens distance adjustment part includes a second driving motor and a second power transmission to transfer power of the second driving motor to the zoom lens.

13. The microscope module of claim 12, wherein the second driving motor includes a linear motor, and the second power transmission includes a driving block coupled with a zoom lens holder for receiving the zoom lens to transfer power of the second driving motor to the zoom lens, a second guide rail adjacent to a lower portion of the zoom lens, and a second guide block coupled to a lower portion of the zoom lens holder to move relative to the second guide rail as the driving block is moved.

14. The microscope module of claim 1, wherein the observation part includes one of an ocular lens, a camera, a photodiode, and a PMT (photo multiplier tube).

15. The microscope module of claim 1, further comprising a first housing and a second housing coupled with the first housing to form an installation space where the objective lens and the reflective lens are installed, wherein the sample is received in a sample receiving part inserted into a sample insertion hole formed through the first housing, and the reflective mirror is disposed below the sample receiving part.

16. The microscope module of claim 3, wherein the mirror surface of the reflective mirror is inclined by an angle of 45° with respect to the second virtual line connecting the objective lens with the observation part.
